(19) United States
(12) Patent Application Publication
(10) Pub. No.: US 2015/0262494 A1
(43) Pub. Date: Sep. 17, 2015

(54) APPARATUS AND METHOD FOR PREDICTING RISK OF COLLISION OF OBJECT

(71) Applicant: ELECTRONICS AND TELECOMMUNICATIONS RESEARCH INSTITUTE, Daejeon (KR)

(72) Inventors: Do-Hyeung KIM, Daejeon (KR); Byung-Doo KIM, Daejeon (KR); Dae-Hee SEO, Daejeon (KR); Kwan-Tae CHO, Daejeon (KR); Joong-Yong CHOI, Uijeongbu-si (KR); Ju-Young KIM, Tongyeong-si (KR); Seung-Hee OH, Daejeon (KR); Byung-Gil LEE, Daejeon (KR); Jung-Chan NA, Daejeon (KR)

(73) Assignee: ELECTRONICS AND TELECOMMUNICATIONS RESEARCH INSTITUTE, Daejeon (KR)

(21) Appl. No.: 14/644,001

(22) Filed: Mar. 10, 2015

(30) Foreign Application Priority Data
Mar. 11, 2014 (KR) 10-2014-0028075

(51) Int. Cl. G08G 9/02; G08G 3/02; G01S 13/93

(52) U.S. Cl. CPC G08G 9/02; G01S 13/9307; G08G 3/02

(57) ABSTRACT

A method and apparatus for predicting the risk of the collision of an object are disclosed herein. The apparatus for predicting the risk of the collision of an object includes an information reception unit, an input processing unit, a risk calculation unit, and a provision unit. The information reception unit receives information transmitted by each of a plurality of heterogeneous transmission apparatuses. The input processing unit processes the information into input information required to calculate a degree of risk of a collision between objects. The risk calculation unit calculates the degree of risk of the collision between the objects using the processed input information. The provision unit externally outputs the degree of risk of the collision, and performs control so that the risk of the collision between the objects can be externally predicted.

### CROSS-REFERENCE TO RELATED APPLICATION

This application claims the benefit of Korean Patent Application No. 10-2014-0028075, filed Mar. 11, 2014, which is hereby incorporated by reference herein in its entirety.

### BACKGROUND

1. Technical Field

The present invention relates generally to an apparatus and method for predicting the risk of the collision of an object and, more particularly, to an apparatus and method that calculate the degree of risk of the collision of an object using weather information and then predict the risk of the collision of the object based on the calculated degree of risk of the collision of the object.

2. Description of the Related Art

Many accidents occur due to collisions between objects. In various fields including the fields of air traffic control and maritime navigation, research and technology related to collisions between objects have been gradually increasing.

For example, Korean Patent Application Publication No. 10-2013-0071580 entitled “Collision Risk Recognition Support System on Multiple Ships by using the Directional Collision Risk” discloses a technology in which the nearest time and nearest distance are calculated using vessel information received from a radar and an automatic identification system (AIS) and then the degree of risk of the collision of a vessel is calculated using a fuzzy theory.

Systems for preventing the risk of a collision between vessels, such as a system disclosed in Korean Patent Application Publication No. 10-2013-0071580, and systems for preventing a collision between airplanes, a collision between vehicles and a collision between satellites are disclosed.

In various fields, a collision between objects may result in damage to many humans and/or a serious large-scale disaster. Although the frequency of accidents is increasingly decreasing thanks to the development of various electronic devices, the accuracy of the quantitative evaluation of the prediction of the risk of a collision is not sufficiently high due to various environmental change factors.

### SUMMARY

At least one embodiment of the present invention is directed to the provision of an apparatus and method that calculate the degree of risk of the collision of an object using weather information and then predict the risk of the collision of the object based on the calculated degree of risk of the collision of the object.

In accordance with an aspect of the present invention, there is provided a method of predicting the risk of the collision of an object, the method including receiving information transmitted by each of a plurality of heterogeneous transmission apparatuses; processing the information into input information required to calculate the degree of risk of a collision between objects; calculating the degree of risk of the collision between the objects using the processed input information; and externally outputting the degree of risk of the collision, and performing control so that the risk of the collision between the objects can be externally predicted.

The information transmitted by each of the plurality of heterogeneous transmission apparatuses may include at least one of information about the state of each of the objects and weather information regarding the object.

The information about the state corresponds to at least one of information about the location, speed, acceleration, size and identification (ID) of the object.

The weather information may correspond to at least one of the direction and velocity of the wind, temperature, humidity, atmospheric pressure, visibility, a rainfall amount, water temperature, an ocean current, the depth of water, and the height, direction and period of waves.

Receiving the information may include receiving the information using at least one of a radar, a sonar, a sonobuoy, optical equipment, a global navigation satellite system (GNSS), automatic dependent surveillance-broadcast (ADS-B) equipment, an automatic identification system (AIS), and a weather sensor.

Processing the information may include, if the information is information about a location and speed of a target, processing the information about the location and speed of the target into input information corresponding to one of the minimum distance between two objects, the time it will take to reach a point of the minimum distance, and the distance between the two objects.

Performing the control may include selecting at least one of gray scaling, enlargement/reduction, and other image overlay methods as an output method corresponding to the degree of risk of the collision when externally outputting the degree of risk of the collision.

In accordance with another aspect of the present invention, there is provided an apparatus for predicting the risk of the collision of an object, the apparatus including an information reception unit configured to receive information transmitted by each of a plurality of heterogeneous transmission apparatuses; an input processing unit configured to process the information into input information required to calculate a degree of risk of a collision between objects; a risk calculation unit configured to calculate the degree of risk of the collision between the objects using the processed input information; and a provision unit configured to externally output the degree of risk of the collision and perform control so that the risk of the collision between the objects can be externally predicted.

The information transmitted by the information reception unit may include at least one of information about the state of each of the objects and weather information regarding the object.

The information about the state may correspond to at least one of information about the location, speed, acceleration, size and ID of the object.

The weather information may correspond to at least one of the direction and velocity of the wind, temperature, humidity, atmospheric pressure, visibility, a rainfall amount, water temperature, an ocean current, the depth of water, and the height, direction and period of waves.

The information reception unit may receive the information using at least one of a radar, a sonar, a sonobuoy, optical equipment, a global navigation satellite system (GNSS), automatic dependent surveillance-broadcast (ADS-B) equipment, an automatic identification system (AIS), and a weather sensor.

The input processing unit, if the information is information about a location and speed of a target, may process the information about the location and speed of the target into input information corresponding to one of the minimum distance between two objects, the time it will take to reach a point of the minimum distance, and the distance between the two objects.

The provision unit may select at least one of gray scaling, enlargement/reduction, and other image overlay methods as an output method corresponding to the degree of risk of the collision when externally outputting the degree of risk of the collision.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating an environment to which an apparatus for predicting the risk of the collision of an object according to an embodiment of the present invention has been applied;

FIG. 2 is a diagram schematically illustrating the configuration of the apparatus for predicting the risk of the collision of an object according to the embodiment; and

FIG. 3 is a flowchart illustrating a method of predicting the risk of the collision of an object according to an embodiment of the present invention.

### DETAILED DESCRIPTION

Embodiments of the present invention will be described in detail below with reference to the accompanying drawings. Repeated descriptions and descriptions of well-known functions and configurations that have been deemed to make the gist of the present invention unnecessarily obscure will be omitted below. The embodiments of the present invention are intended to fully describe the present invention to persons having ordinary knowledge in the art to which the present invention pertains. Accordingly, the shapes, sizes, etc. of components in the drawings may be exaggerated to make the description obvious.

An apparatus and method for predicting the risk of the collision of an object according to embodiments of the present invention are described in detail below with reference to the accompanying drawings.

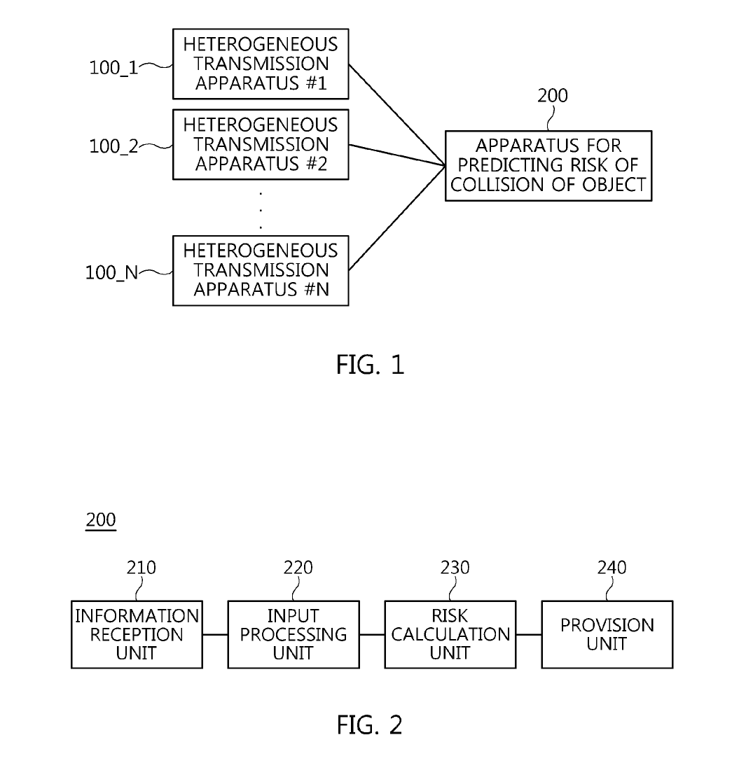

FIG. 1 is a diagram illustrating an environment to which an apparatus 200 for predicting the risk of the collision of an object according to an embodiment of the present invention has been applied. FIG. 2 is a diagram schematically illustrating the configuration of the apparatus 200 for predicting the risk of the collision of an object according to the present embodiment.

Referring to FIG. 1, the apparatus 200 for predicting the risk of the collision of an object operates in conjunction with a plurality of heterogeneous transmission apparatuses 100_1 to 100_N.

More specifically, the apparatus 200 for predicting the risk of the collision of an object receives information from the plurality of heterogeneous transmission apparatuses 100_1 to 100_N, and predicts the risk of the collision of an object using the received information.

The plurality of heterogeneous transmission apparatuses 100_1 to 100_N may be homogeneous apparatuses that provide the same type of information, or may be heterogeneous apparatuses that provide the same type of information or different types of information.

Each of the plurality of heterogeneous transmission apparatuses 100_1 to 100_N sends information about the state of an object and weather information via, for example, a radar, a sonar, a sonobuoy, optical equipment, a global navigation satellite system (GNSS), automatic dependent surveillance-broadcast (ADS-B) equipment, an automatic identification system (AIS), a weather sensor, or the like. Although the plurality of heterogeneous transmission apparatuses 100_1 to 100_N may be a plurality of pieces of equipment that provide information required to predict the risk of a collision, they are not limited thereto.

In order to calculate more accurate collision risk information based on various environmental changes that are encountered by an object, the apparatus 200 for predicting the risk of the collision of an object calculates the degree of risk of a collision between objects based on information about the state of each of the objects and weather information regarding the object provided by the plurality of heterogeneous transmission apparatuses 100_1 to 100_N. In this case, the information about the state of the object may include information about the location, speed, acceleration, size and ID of the object. Furthermore, the weather information may include the direction and velocity of the wind, temperature, humidity, atmospheric pressure, visibility, a rainfall amount, water temperature, an ocean current, the depth of water, and the height, direction and period of waves.

Referring to FIG. 2, the apparatus 200 for predicting the risk of the collision of an object may include an information reception unit 210, an input processing unit 220, a risk calculation unit 230, and a provision unit 240.

The information reception unit 210 receives input information transmitted by each of the plurality of heterogeneous transmission apparatuses 100_1 to 100_N. In this case, the information transmitted by each of the plurality of heterogeneous transmission apparatuses 100_1 to 100_N is different from information transmitted by other heterogeneous transmission apparatuses.

The input processing unit 220 processes at least one piece of input information, received by the information reception unit 210, into input required to calculate the degree of risk of a collision.

More specifically, if at least one piece of input information received by the information reception unit 210 is information about the location and speed of a target, the input processing unit 220 may process the information about the location and speed of the target into a minimum distance between the two objects, the time it will take to reach a point of the minimum distance, and the distance between the two objects. Furthermore, the input processing unit 220 may process at least one piece of input information received by the information reception unit 210 into a visible distance itself or into a level equal to the level of the visible distance.

The risk calculation unit 230 calculates the degree of risk of the collision using the input information processed by the input processing unit 220.

The risk calculation unit 230 according to the present embodiment may calculate the degree of risk of the collision by applying the processed input information to various methods, such as a fuzzy theory and a probability theory. However, the various method are not limited thereto.

The provision unit 240 processes the degree of risk of the collision, calculated by the risk calculation unit 230, into information in another form and then provides the processed information, displays the degree of risk of the collision without change, or processes the degree of risk of a collision into information of another form, displays the processed information and then provides the processed information to a user. In this case, the provision unit 240 displays the degree of risk of the collision using at least one of gray scaling, enlargement/reduction, and other image overlay methods based on the level of the degree of risk of a collision.

Although the provision unit 240 according to the present embodiment has been illustrated as being included in the apparatus 200 for predicting the risk of the collision of an object, the provision unit 240 is not limited thereto.

As described above, when the quantitative evaluation of the risk of the collision of an object, such as an airplane or a vessel, is attempted, the apparatus 200 for predicting the risk of the collision of an object according to the present embodiment uses weather information provided by various weather sensors as factors for preventing a collision, thereby being able to provide more accurate information about the degree of risk of a collision.

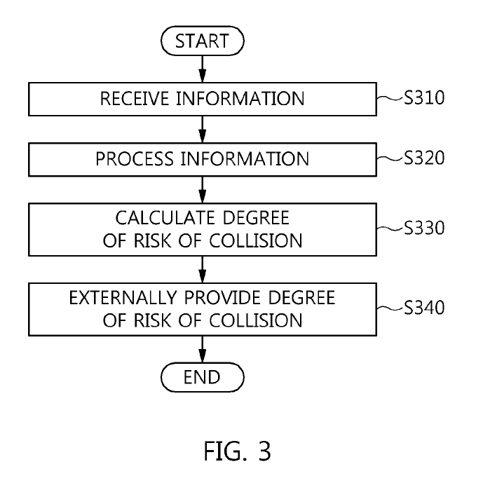

A method of predicting the risk of the collision of an object is described in detail with reference to FIG. 3.

FIG. 3 is a flowchart illustrating a method of predicting the risk of the collision of an object according to an embodiment of the present invention.

First, the apparatus 200 for predicting the risk of the collision of an object operates in conjunction with the plurality of heterogeneous transmission apparatuses 100_1 to 100_N in order to calculate more accurate collision risk information based on various environmental changes that are encountered by each object. In this case, each of the plurality of heterogeneous transmission apparatuses 100_1 to 100_N sends information about the state of an object and weather information via, for example, a radar, a sonar, a sonobuoy, optical equipment, a global navigation satellite system (GNSS), automatic dependent surveillance-broadcast (ADS-B) equipment, an automatic identification system (AIS), a weather sensor, or the like.

Referring to FIG. 3, the apparatus 200 for predicting the risk of the collision of an object receives input information transmitted by each of the plurality of heterogeneous transmission apparatuses 100_1 to 100_N at step S310. In this case, the input information may include at least one of information about the state of each object and weather information regarding the object. Furthermore, the information about the state of each object may include information about the location, speed, acceleration, size and ID of the object. The weather information may include the direction and velocity of the wind, temperature, humidity, atmospheric pressure, visibility, a rainfall amount, water temperature, an ocean current, the depth of water, and the height, direction and period of waves.

The apparatus 200 for predicting the risk of the collision of an object processes at least one piece of input information, received at step S310, into input required to calculate the degree of risk of a collision at step S320.

For example, if the input information is information about the location and speed of a target, the apparatus 200 for predicting the risk of the collision of an object may process information about the location and speed of the target into a minimum distance between the two objects, the time it will take to reach a point of the minimum distance, and the distance between the two objects.

At step S330, the apparatus 200 for predicting the risk of the collision of an object calculates the degree of risk of the collision using the input information processed at step S320.

The apparatus 200 for predicting the risk of the collision of an object according to the present embodiment may calculate the degree of risk of the collision by applying the processed input information to various methods, such as a fuzzy theory and a probability theory. However, the various methods are not limited thereto.

The apparatus 200 for predicting the risk of the collision of an object processes the degree of risk of the collision, calculated at step S330, into information in another form and then provides the processed information, displays the degree of risk of the collision without change, or processes the degree of risk of a collision into information in another form, displays the processed information and then provides the processed information to a user at step S340.

That is, the apparatus 200 for predicting the risk of the collision of an object externally outputs the degree of risk of the collision calculated at step S330, and then performs control so that the risk of the collision between the objects can be externally predicted.

As described above, in accordance with the present invention, the apparatus and method for predicting the risk of the collision of an object calculate the degree of risk of the collision of an object using weather information. Accordingly, more accurate information about the degree of risk of the collision can be calculated by effectively incorporating an environmental change encountered by a corresponding object into the degree of risk of the collision, and the risk of the collision can be more accurately predicted based on the calculated degree of risk of the collision.

As described above, the optimum embodiments have been disclosed in the drawings and the specification. Although specific terms have been used herein, they have been used merely for the purpose of describing the present invention, but have not been used to restrict their meanings or limit the scope of the present invention set forth in the claims. Accordingly, it will be understood by those having ordinary knowledge in the relevant technical field that various modifications and other equivalent embodiments can be made. Therefore, the true ranges of protection of the present invention should be defined based on the technical spirit of the attached claims.

What is claimed is:

1. A method of predicting a risk of a collision of an object, the method comprising:
receiving information transmitted by each of a plurality of heterogeneous transmission apparatuses;
processing the information into input information required to calculate a degree of risk of a collision between objects;
calculating the degree of risk of the collision between the objects using the processed input information; and
externally outputting the degree of risk of the collision, and performing control so that the risk of the collision between the objects can be externally predicted.

2. The method of claim 1, wherein the information transmitted by each of the plurality of heterogeneous transmission apparatuses comprises at least one of information about a state of each of the objects and weather information regarding the object.

3. The method of claim 2, wherein the information about the state corresponds to at least one of information about a location, speed, acceleration, size and identification (ID) of the object.

4. The method of claim 2, wherein the weather information corresponds to at least one of a direction and velocity of a wind, temperature, humidity, atmospheric pressure, visibility, a rainfall amount, a water temperature, an ocean current, a depth of water, and a height, direction and period of waves.

5. The method of claim 1, wherein receiving the information comprises receiving the information using at least one of a radar, a sonar, a sonobuoy, optical equipment, a global navigation satellite system (GNSS), automatic dependent surveillance-broadcast (ADS-B) equipment, an automatic identification system (AIS), and a weather sensor.

6. The method of claim 1, wherein processing the information comprises, if the information is information about a location and speed of a target, processing the information about the location and speed of the target into input information corresponding to one of a minimum distance between two objects, a time it will take to reach a point of the minimum distance, and a distance between the two objects.

7. The method of claim 1, wherein performing the control comprises selecting at least one of gray scaling, enlargement/reduction, and other image overlay methods as an output method corresponding to the degree of risk of the collision when externally outputting the degree of risk of the collision.

8. An apparatus for predicting a risk of a collision of an object, the apparatus comprising:
an information reception unit configured to receive information transmitted by each of a plurality of heterogeneous transmission apparatuses;
an input processing unit configured to process the information into input information required to calculate a degree of risk of a collision between objects;
a risk calculation unit configured to calculate the degree of risk of the collision between the objects using the processed input information; and
a provision unit configured to externally output the degree of risk of the collision and perform control so that the risk of the collision between the objects can be externally predicted.

9. The apparatus of claim 8, wherein the information transmitted by the information reception unit comprises at least one of information about a state of each of the objects and weather information regarding the object.

10. The apparatus of claim 9, wherein the information about the state corresponds to at least one of information about a location, speed, acceleration, size and ID of the object.

11. The apparatus of claim 9, wherein the weather information corresponds to at least one of a direction and velocity of a wind, temperature, humidity, atmospheric pressure, visibility, a rainfall amount, a water temperature, an ocean current, a depth of water, and a height, direction and period of waves.

12. The apparatus of claim 8, wherein the information reception unit receives the information using at least one of a radar, a sonar, a sonobuoy, optical equipment, a global navigation satellite system (GNSS), automatic dependent surveillance-broadcast (ADS-B) equipment, an automatic identification system (AIS), and a weather sensor.

13. The apparatus of claim 8, wherein the input processing unit, if the information is information about a location and speed of a target, processes the information about the location and speed of the target into input information corresponding to one of a minimum distance between two objects, a time it will take to reach a point of the minimum distance, and a distance between the two objects.

14. The apparatus of claim 8, wherein the provision unit selects at least one of gray scaling, enlargement/reduction, and other image overlay methods as an output method corresponding to the degree of risk of the collision when externally outputting the degree of risk of the collision.
